(19) United States
(12) Patent Application Publication
(10) Pub. No.: US 2008/0110027 A1
(43) Pub. Date: May 15, 2008

(54) MULTIBLADE KNIFE UNIT

(75) Inventors: Brett P. Seber, Escondido, CA (US); Eric B. Carmichael, Encinitas, CA (US); Wesley James Tom, Escondido, CA (US)

Correspondence Address: KELLY LOWRY & KELLEY, LLP, 6320 CANOGA AVENUE, SUITE 1650, WOODLAND HILLS, CA, 91367, US

(73) Assignee: I.D.L. TECH TOOLS, LLC, Summit, NJ (US)

(21) Appl. No.: 11/559,362

(22) Filed: Nov. 13, 2006

(51) Int. Cl. B26B 3/06

(52) U.S. Cl. 30/152; 30/160; 30/159

(57) ABSTRACT

A multiblade knife unit includes knife blades of different type normally stored within and adapted for deployment from a common end of a handle housing. A pivoting knife blade is supported for pivotal movement between a stored position nested substantially within one side edge of the handle housing, and a deployed position projecting from one end of the handle housing. A razor-type utility knife blade is supported by a slide clip for sliding displacement between a retracted position stored and concealed within the handle housing, and an advanced position projecting from said one end of the handle housing. A release button on the handle housing is depressed for releasing the utility knife blade from the slide clip for facilitating quick and easy slide-out blade removal and replacement. In one form, the knife unit may further include driver bits interchangeably mounted at an opposite end of the handle housing.

### BACKGROUND OF THE INVENTION

This invention relates generally to an improved multiblade knife unit including a plurality of knife blades of different type normally stored within and adapted for deployment from a handle housing. More particularly, this invention relates to an improved multiblade knife unit wherein multiple knife blades such as a pivotally mounted knife blade and a slidably mounted utility blade are deployable from a common end of the handle housing.

Multiblade knife units are generally known in the art, wherein a plurality of knife blades are carried by a common knife handle. In such knife units, the handle comprises a housing structure adapted for movably supporting each of the multiple knife blades for individual displacement between a normal stored position nested at least partially within the handle housing, and a deployed position with a blade cutting edge exposed for use. In this regard, conventional so-called pocket knives are known wherein multiple pivoting knife blades are carried by the handle housing for pivoting displacement between the stored and deployed positions at a common end of the handle housing. Such pivoting knife blades normally comprise different-sized blades of a common style, e.g., such as conventional knife blades each having a cutting edge formed along one side thereof. In multiblade knife units of this type, a single one of the multiple knife blades is normally deployed for use at any given time. By contrast, while multiple blades can be deployed simultaneously, the blades typically define parallel cutting edges which are not normally useful in this configuration for performing different types of cutting tasks.

In recent years, interest has developed in alternative multiblade knife units having a plurality of knife blades of different types, particularly such as at least one pivotally mounted knife blade in combination with at least one slidably mounted razor-type utility knife blade. Such alternative multiblade knife units have incorporated these different types of knife blades in a common handle housing each for displacement between stored and deployed positions. In this regard, slidably mounted razor-type utility knives are also known in the art, and typically include a removably mounted razor blade having an extremely sharp cutting edge used to perform a variety of specialized cutting tasks, such as trimming wallboard during building construction and/or remodeling. However, multiblade knife units which combine a slidably mounted utility knife blade with a conventional pivotally mounted knife blade have generally deployed these different-style cutting blades from opposite ends of a common handle housing. Once again, while it is possible to deploy both types of knife blades at the same time, the oppositely projecting cutting edges pose a significant risk of use injury.

The present invention provides an improved multiblade knife unit having knife blades of different types, such as pivotally mounted knife blade and a slidably mounted utility blade, adapted for individual or concurrent deployment from a common end of a handle housing.

### SUMMARY OF THE INVENTION

In accordance with the invention an improved multiblade knife unit includes knife blades of different type normally stored within and adapted for deployment from a common end of a handle housing. A first, pivoting knife blade is supported for pivotal movement between a stored position nested substantially within one side edge of the handle housing, and a deployed position projecting from one end of the handle housing. A second, razor-type utility knife blade is supported by a slide clip for sliding displacement between a retracted position stored and concealed within the handle housing, and an advanced position projecting from said one end of the handle housing. The two knife blades can be deployed independently, or concurrently.

The pivotally mounted knife blade, in the preferred form, includes a short stub post positioned in spaced relation to the pivotally mounted end thereof, for fingertip engagement to facilitate knife blade displacement from the normally stored to the deployed position. A spring plate mounted within the handle housing shifts laterally in a first direction when the pivoting knife blade is in the deployed position to engage and lock with a matingly shaped base end of the knife blade, thereby precluding unintended return movement from the deployed position to the stored position. An edge of this spring plate is exposed and configured for fingertip engagement to shift the spring plate in a second direction, thereby releasing the knife blade and permitting pivotal return thereof to the stored position.

The slidably mounted utility blade is carried by a slide clip mounted within the handle housing for displacement between the retracted and advanced positions. A thumb detent on the slide clip is exposed through a slot formed in the handle housing to facilitate slide clip displacement. At least one mounting key on the slide clip is normally seated within a mating mounting recess formed in the utility blade, whereby slide clip displacement shifts the utility blade between the retracted and advanced positions.

A release button on the handle housing is depressed for releasing the utility knife blade from the slide clip, thereby facilitating quick and easy slide-out blade removal and replacement. The release button is carried at one end of a spring tab mounted within the handle housing, with said release button being externally exposed through a button port formed in the handle housing. When the slide clip is shifted to the advanced position, the release button can be depressed to retract the mounting key on the slide clip from the mounting recess on the utility blade, thereby releasing the utility blade for manual grasping and slide-out separation from the slide clip and handle housing. Accordingly, a replacement utility blade with a sharp cutting edge can be slidably installed on the slide clip, followed by spring-retraction of the release button for re-engagement of the slide clip mounting key with the blade mounting recess.

In one form, the knife unit may further include screwdriver bits, or alike such as scribes, or marking devises interchangeably mounted at an opposite end of the handle housing.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is top perspective view illustrating a multiblade knife unit in accordance with one preferred form of the present invention;

FIG. 2 is a top perspective view similar to FIG. 1, and showing a pivoting knife blade in a deployed position projecting outwardly from a handle housing;

FIG. 3 is a top perspective view similar to FIGS. 1 and 2, but depicting the pivoting knife blade in a stored position nested partially within the handle housing, and a razor-type utility blade in a slidably advanced position;

FIG. 4 is a bottom perspective view showing the utility blade in the advanced position projecting outwardly from the handle housing;

FIG. 5 is a partially exploded bottom perspective view illustrating the pivoting knife blade in the stored position, and the utility blade (in dotted lines) in the advanced position;

FIG. 6 is a further exploded bottom perspective view;

FIG. 7 is a compact perspective view similar to a portion of FIG. 6, and showing the internal components for slide-fit mounting of the utility blade within the handle housing;

FIG. 8 is an exploded perspective view of FIG. 7;

FIG. 9 is an enlarged sectional view taken generally on the line 9-9 of FIG. 4;

FIG. 10 is an enlarged sectional view similar to FIG. 9, but illustrating depression of a release button on the handle housing for slide-fit removal of the utility blade from the handle housing;

FIG. 11 is a side elevation view of the knife unit, taken generally on the line 11-11 of FIG. 1, and depicting the pivoting knife blade in the stored position;

FIG. 12 is a side elevation view similar to FIG. 9, but taken generally on the line 12-12 of FIG. 2 and showing the pivoting knife blade in the deployed position;

FIG. 13 is a top perspective view similar to FIG. 2, but showing one alternative preferred form of the invention; and

FIG. 14 is an enlarged, fragmented, and partially exploded top perspective view corresponding generally with the encircled region 14 of FIG. 13.

### DETAILED DESCRIPTION OF THE PREFERRED EMBODIMENTS

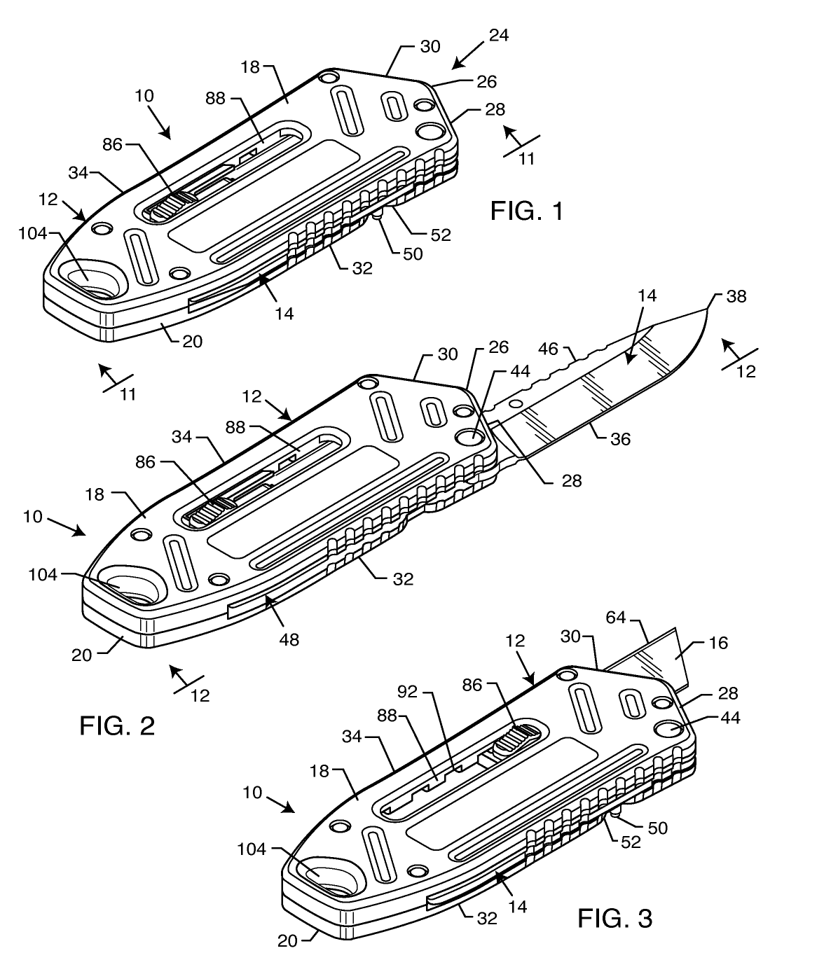

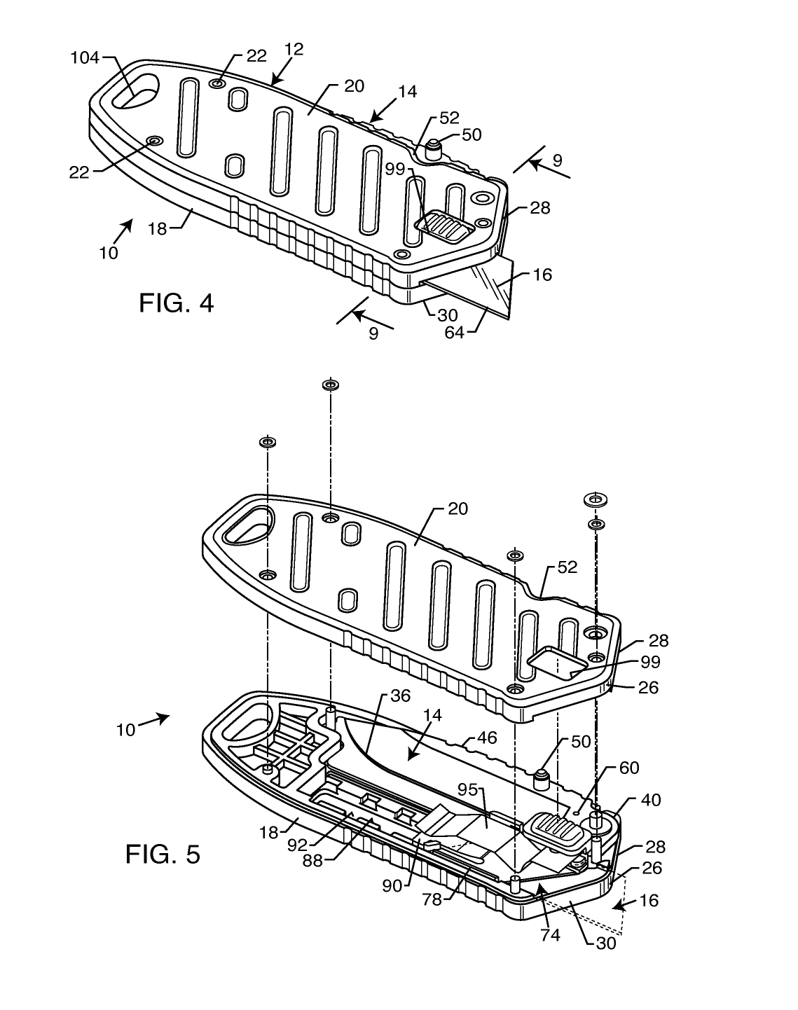

As shown in the exemplary drawings, a multiblade knife unit referred to generally in FIGS. 1-4 by the reference numeral 10 comprises a handle housing 12 carrying a plurality of knife blades of different types, wherein the multiple knife blades are adapted for movement between a normal stored position and a deployed position projecting outwardly from a common end of the handle housing 12. The exemplary drawings show the multiple knife blades in the form of a pivoting knife blade 14 (FIG. 2) and a slidably mounted razor-type utility blade 16 (FIGS. 3-4). Both blades 14, 16 can be deployed at the same time, if desired.

The multiblade knife unit 10 of the present invention generally comprises the handle housing 12 having a relatively compact and preferably externally textured or grooved geometry for facilitated manual grasping and holding during use. As shown, the handle housing 12 comprises an upper housing member 18 having a size and shape for mated fit with a lower housing member 20, and for secure interconnection therewith as by means of a plurality of rivet-type fasteners 22 or the like. When assembled, the upper and lower housing members 18, 20 support and encase the knife blades 14, 16 and associated mechanisms for displacing these knife blades 14, 16 between their respective stored and deployed positions. The housing member 18, 20 may be constructed conveniently from a lightweight reinforced plastic material.

In general terms, the illustrative pair of knife blades 14, 16 are mounted within the handle housing 12 generally in side-by-side relation. In this regard, a front end 24 of the handle housing 12 is shown to include a generally pointed or forwardly projecting central nose 26 bounded on opposite sides by a matched pair of tapered faces 28 and 30 which extend from the nose 26 in a lateral and angularly rearward direction toward the associated side edges 32 and 34 of the handle housing 12. In other words, the front end 24 of the handle housing 12 has a generally V-shaped configuration. The pivoting knife blade 14 is supported by the handle housing 12 for projecting in the deployed position (as viewed in FIG. 2) from the front tapered face 28 of the handle housing 12, whereas the slidably mounted utility blade 16 is supported for projecting in the deployed position (as viewed in FIGS. 3-4) from the front tapered face 30 of the handle housing 12. Accordingly, the two knife blades 14, 16 are independently supported by the handle housing 12 for separate and independent displacement between their respective stored and deployed positions. In this regard, although not shown in the exemplary drawings, persons skilled in the art will recognize and appreciate that the two knife blades 14, 16 can both be deployed at the same time, if desired.

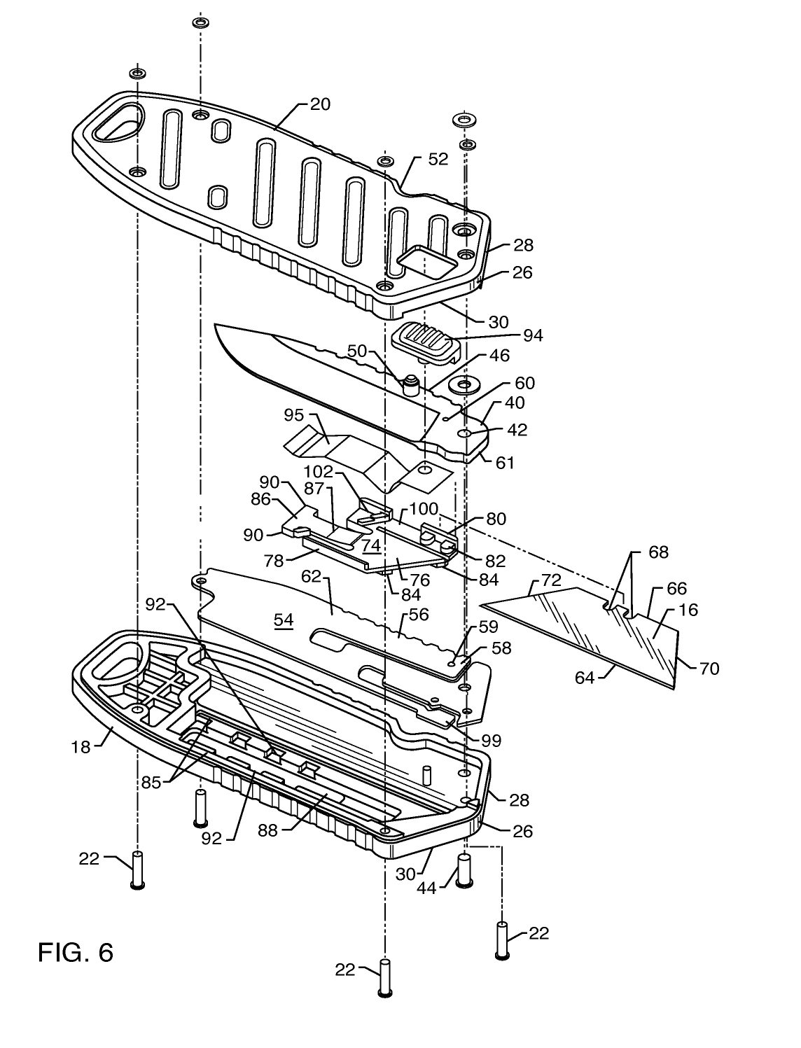

The pivoting knife blade 14 as shown comprises a conventional knife blade having an elongated cutting edge 36 formed along one side thereof and terminating at a pointed distal end tip 38. An oppositely disposed and non-sharpened base end 40 (shown best in FIG. 6) has a pivot port 42 formed therein for secure mounting between the housing members 18, 20 as by means of suitable pivot pin 44 fastened between the housing members 18, 20 near the angled front face 28. The knife blade 14 further includes a blunt and preferably serrated side edge 46 disposed opposite the cutting edge 36.

The pivoting knife blade 14 is sized and shaped for normal nested reception in the stored position seated at least partially within a laterally open slot 48 defined in the housing side edge 32 between the assembled housing members 18, 20 (shown best in FIGS. 2 and 9-10). In this stored position, the sharp cutting edge 36 on the knife blade 14 is in an inboard-facing orientation (shown best in FIG. 5), and the blunt side edge 46 is in an outboard-facing orientation, thereby safeguarding against accidental contact with the cutting edge 36. A short stub post 50 mounted on the knife blade 14 in a position spaced a short distance from the base end 40 is nested at least partially within a laterally open notch 52 defined by the lower housing member 20.

To displace the pivoting knife blade 14 from the stored position to the deployed position, the stub post 50 is sufficiently exposed within the notch 52 for fingertip access as by the user's thumb for swinging the knife blade 14 outwardly from the stored position within the nested slot 48 to the deployed position projecting forwardly from the angled front face 28 at the front end 24 of the handle housing 12. In this orientation, the pointed distal end tip 38 is presented in a forward direction extending away from the housing handle 12, and the cutting edge 36 is presented in a laterally outboard direction relative to the handle housing 12.

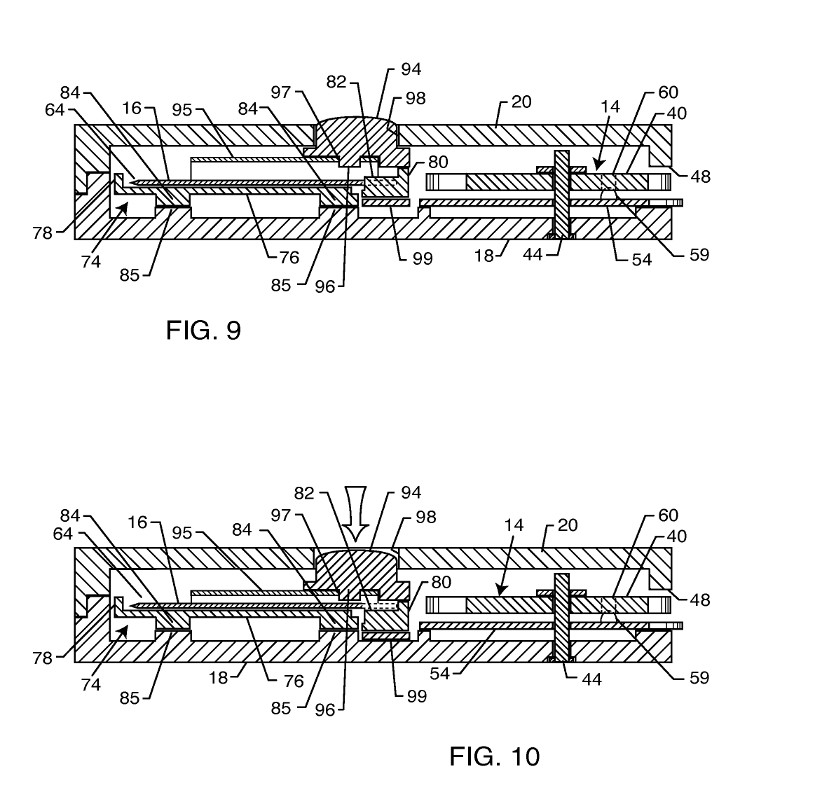

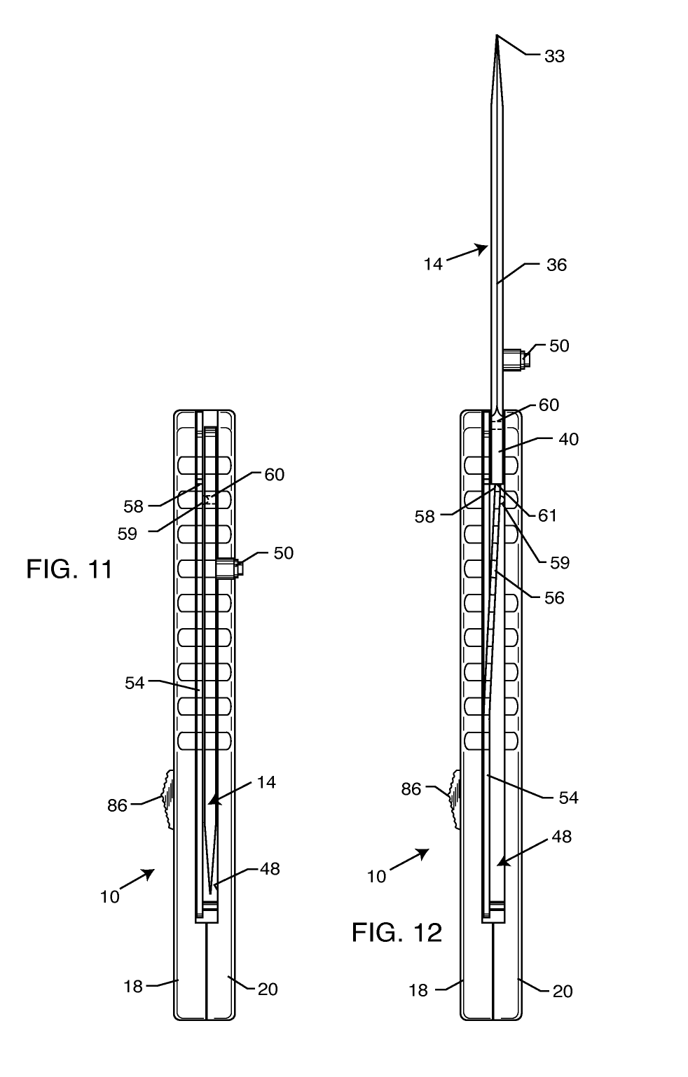

In accordance with one aspect of the invention, the knife unit 10 includes a releasible locking device for releasibly locking the pivoting knife blade 14 in the deployed position, thereby safeguarding against undesired or premature re-folding of the knife blade 14 back to the stored position. In a preferred embodiment, a spring member such as a spring plate 54 (shown best in FIGS. 6-10) is mounted within the handle housing 12 in a position sandwiched between the housing members 18, 20. This spring plate 54 includes a spring member 56 for locking the pivoting knife blade in either a deployed or retracted position. The spring member 56 has a front end 58 for locking the pivoting knife blade 14 in a deployed position as further described herein. When the pivoting knife blade 14 is in the stored position, a ball detent 59, located near the front end 58 of the spring member 56, engages a ball detent socket 60 as illustrated in FIGS. 9-10. The ball detent 59 and the ball detent socket 60 combine to releasibly retain the pivoting knife blade 14 in the fully stored position. Pressure exerted upwardly from the spring member 56 against the bottom of the pivoting knife blade 14 locates the ball detent 59 within the ball detent socket 60 while the knife blade 14 is in this fully stored position (FIG. 11).

Pivoting the knife blade 14 toward the fully deployed position (FIG. 12) disengages the ball detent 59 from the ball detent socket 60. The knife blade 14 pivots across the tip of the ball detent 59, thereby experiencing minimal resistance because of the limited surface area contact between the tip of the ball detent 59 and the surface of the knife blade 14. When the knife blade 14 reaches the fully deployed position, the front end 58 of the spring member 56 shifts downwardly to the position shown in FIG. 12. This front end 58 defines a relatively flat edge which moves behind and engages a corresponding flat edge 61 (FIGS. 6, 11-12) of the knife blade base end 40, when the knife blade 14 is in the fully deployed position. In a particularly preferred embodiment, both the front end 58 and the flat edge 61 are formed having engageable 10° angles, although any combination of engageable angles are possible. As a result, the front end 58 of the spring plate 54 effectively locks and blocks the pivoting knife blade 14 in the deployed position (as shown best in FIG. 12). A person of ordinary skill in the art will readily recognize that many different releasible locking mechanisms are available for use with the present invention in order to effectively lock the pivoting knife blade 14 in the fully deployed position. Such devices might include spring, clip, snap, or non-friction mechanisms, and may utilize notches, pins, buttons, bars, coils, nuts and/or bolts or any combination thereof.

The pivoting knife blade 14 is quickly and easily released or unlocked for return pivoting motion from the deployed position to the stored position, when and if desired. The spring plate 54 defines a laterally outboard-presented serrated edge 62 along the external portion of the spring member 56, which terminates substantially coextensive with the adjoining side edge or side margin 32 of the housing members 18, 20. This serrated edge 62 is thus exposed for easy manipulation manually to shift the flat-shaped front end 58 of the spring member 56 upwardly within the slot 48 for spring member misalignment with the plane of the knife blade 14. In this misaligned position of the spring member 56, the knife blade 14 can be pivotally displaced back to the stored position nested at least partially within the side-open slot 48 in the handle housing 12. During the pivoting motion, the knife blade 14 contacts and rotates along the tip of the ball detent 59. When the knife blade 14 is in the fully stored position, the ball detent 59 re-engages the ball detent socket 60 as previously described. Upon subsequent return movement of the knife blade 14 back to the deployed position (FIG. 2), the spring member 56 on the spring plate 54 biases the spring member front end 58 against the knife blade 14 (FIG. 12) for automatically yet releasibly re-locking the knife blade 14 in the deployed position.

The utility blade 16 as shown best in FIG. 6 comprises a conventional razor-type knife blade having a generally trapezoidal shape with an elongated side edge defining a razor-sharp cutting edge 64. A comparatively shorter and relatively blunt side edge 66, disposed opposite the cutting edge 64, has a pair of laterally open mounting recesses 68 formed therein. Leading and trailing edges 70 and 72 of the utility blade 16 respectively extend angularly forwardly and angularly rearwardly from the blunt edge 68 to the cutting edge 64.

This utility blade 16 is adapted for reversible and removable mounting onto a slide clip 74 (FIGS. 6-8) carried between the two housing members 18, 20 for fore-aft sliding displacement to shift the utility blade 16 between the stored position concealed within the handle housing 12 and the deployed position projecting forwardly from the angularly tapered face 30 at the front end 24 of the handle housing. In this regard, the utility blade 16 is seated on the slide clip 74 with a rear portion or rear half of the blade 16 supported on a platen 76 which extends between a lower rail 78 and an upper rail 80. A pair of mounting keys 82 are formed adjacent the upper rail 80 for seated reception into the mounting recesses 68 formed in the utility blade 16. In a preferred form, the slide clip 74 is constructed from a molded plastic material, spring metal, stamped, or similar material suitable for carrying the blade 16 without significant damage to the razor-sharp cutting edge 64 supported by the lower rail 78. Importantly, when the utility blade 16 is thus mounted onto the slide clip 74, a forward portion or forward half of the blade 16 protrudes forwardly from the slide clip 74.

The slide clip 74 is captured between the assembled housing members 18, 20 for fore-aft sliding displacement. In this regard, the assembled housing members 18, 20 cooperatively define a slide track for retaining and guiding the slide clip 74 with utility blade 16 supported thereon between the retracted (stored) and advanced (deployed) positions. A track extension 84 of the side clip 74 mates to a corresponding track ledge 85 (shown best in FIGS. 9-10) formed in the upper housing member 18 to facilitate movement between retracted and advanced positions. A thumb key or thumb detent 86 on a rear end of a short spring arm 87 forms an integral portion of the slide clip 74, and wherein this thumb detent 86 is externally exposed through a fore-aft elongated track port 88 (FIGS. 1-3 and 5-6) formed in the upper housing member 18. At least one and preferably a pair of laterally elongated side wings 90 formed at the base of this thumb detent 86 are sized to project at least partially into aligned detent seats 92 formed in the lower housing member 20 at an inboard surface thereof lining the track port 88 as illustrated in FIG. 6.

Accordingly, by depressing the thumb detent 86 sufficiently to disengage the side wings 90 from the associated detent seats 92, the slide clip 74 with the utility blade 16 can be shifted forwardly or rearwardly relative to the track port 88. In the rearmost slide clip position along the track port 88, the utility blade 16 is retracted to the stored and concealed position. Conversely, in the forwardmost slide clip position along the track port 88, the utility blade 16 is shifted to a fully exposed deployed position with the cutting edge 64 exposed laterally outwardly relative to the handle housing 12 in a direction opposite to the cutting edge 36 of the knife blade 14 in a deployed position. The detent seats 92 engage the side wings 90 for releasibly locking the slide clip 74 and blade 16 in the desired stored or deployed position. Multiple intermediate sets of the detent seats 92 are provided for multiple partially deployed positions of the utility blade 16.

In accordance with a further aspect of the invention, the utility blade 16 is adapted for quick and easy removal from the handle housing 12, without requiring disassembly of the housing members 18, 20. In this regard, such removal of the utility blade 16 is periodically necessary to reverse the blade 16 relative to the slide clip 74, and/or to replace a worn blade with a new one.

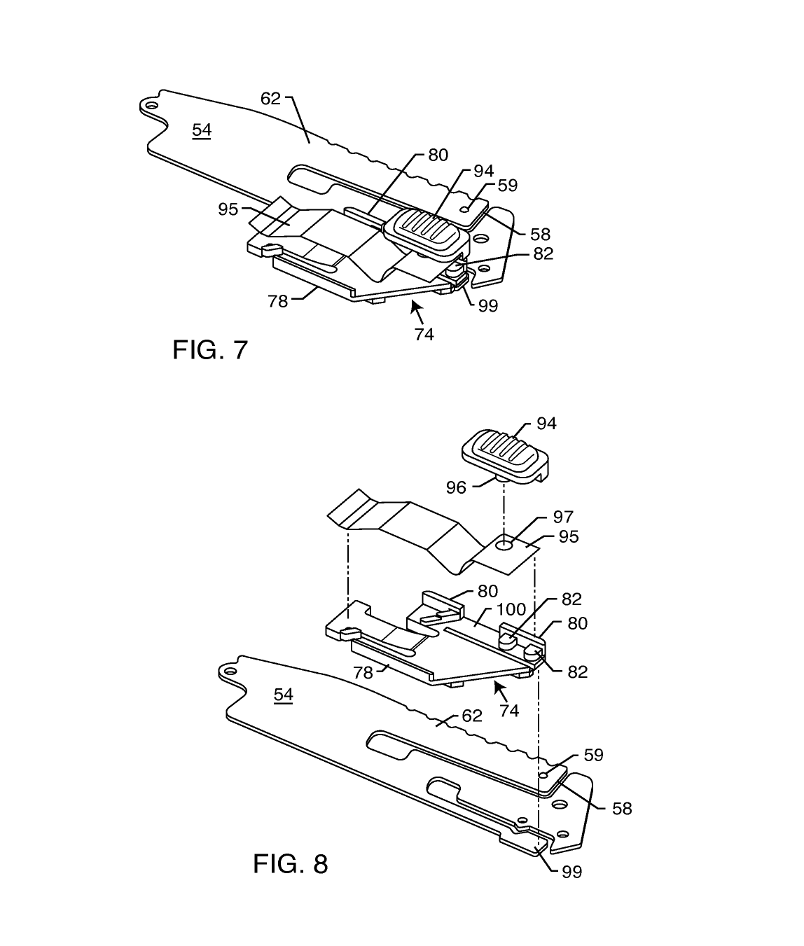

More particularly, when the slide clip 74 is in the forwardmost position for supporting the utility blade 16 in the deployed position, the slide clip 74 is oriented with its upper rail 80 in a position directly underlying a release button 94 (shown best in FIGS. 7-10) and tensioned upwardly by a release spring 95 mounted within the handle housing 12. FIG. 8 shows an exploded perspective view of the release button 94 having a connection post 96 that locates the release button 94 in an aperture 97 formed in the release spring 95. The release spring 95 is widened and lengthened to keep the utility knife blade 16 from rattling. The release spring 95 provides continual upward pressure to the release button 94, even when the slide clip 74 is in the stored position. Additionally, the release spring 95 provides continual downward pressure on the thumb detent 86 to ensure continual external exposure through the lower housing member 18 in the retracted and deployed positions. Importantly, the release button 94 is externally exposed through a matingly shaped release port 98 formed in the lower housing member 20 for convenient fingertip depression.

As previously described, and as shown best in FIGS. 9-10, the upper rail 80 on the slide clip 74 underlies the release button 94 when the slide clip 74 is in the forward most position with a portion of the utility blade 16 projecting from the front end 24 of the handle housing 12. Depression of the release button 94 in this orientation shifts the upper rail 80, associated mounting keys 82, and a spring tab 99 relative to the utility blade 16, in a direction toward the opposite housing member 18. In this regard, it is noted that the upper rail 80 and mounting keys 82 of the slide clip 74 are carried generally at a free end of yet another short spring arm 100 formed integrally with the slide clip 74, to accommodate this shifting displacement relative to the blade-supporting platen 76 of the slide clip 74. This clip spring arm 100 is supported (in the forward most slide position) on the spring tab 99 of the spring plate 54. By configuring the upper rail 80 so that it is taller than the mounting keys 82, depression of the release button 94 can displace the mounting keys (downwardly, as viewed in FIG. 10) sufficiently to clear the blade mounting recesses 68, thereby releasing the blade 16 for manual grasping and slide-out removal from the handle housing 12.

The utility blade 16 can be re-installed quickly and easily into the handle housing 12 in the same or a reversed orientation, or a replacement blade 16 can be installed, by sliding the blade rearwardly into the handle housing 16 while holding the release button 94 in the depressed position. When the rear margin of the re-installed blade 16 engages an upstanding backstop structure 102 on the slide clip 74, the release button 94 is released to permit spring-loaded travel of the mounting keys 82 (upwardly, as viewed in FIG. 10) into re-engagement with the blade mounting recesses 68.

Various modifications and improvements in and to the multiblade knife unit 10 of the present invention will be apparent to persons skilled in the art. As one example, the handle housing 12 may incorporate a tether port 104 (FIGS. 1-4) for receiving a tether (not shown) or the like, if desired.

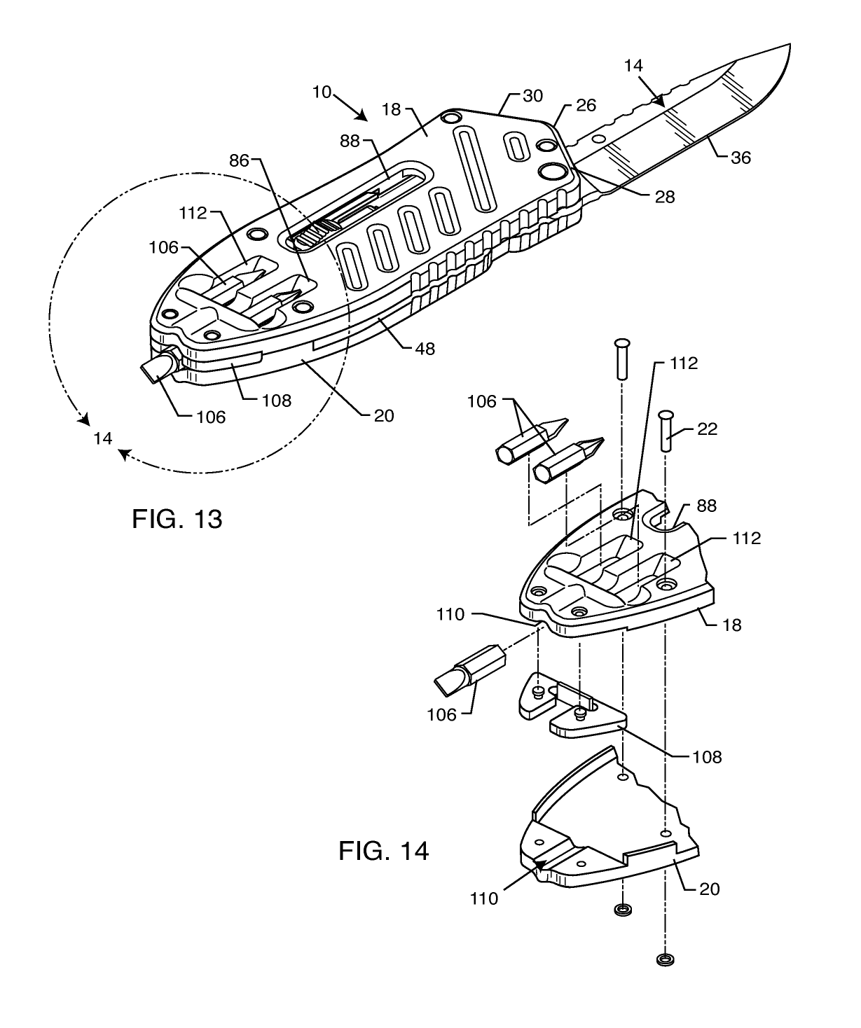

Alternately, as viewed in FIGS. 13-14, the handle housing 12 can be modified to include a plurality of driver bits such as screwdriver bits 106 for selective deployment at the end opposite the deployed knife blade or blades, such as the pivoting knife blade 14 as shown. In this alternative embodiment, the housing members 18, 20 are adapted in combination with a plate-shaped insert 108 to define a hex-shaped bit socket 110 or the like for removably receiving and supporting a selected one of the bits 106, such as flat-blade screwdriver bits or different sizes, and/or one or more Phillips-type, hex, torqux bits. A driver bit 106 supported in the hex socket 110 projects rearwardly from the handle housing 12, in a direction opposite the deployed knife blades, for appropriate use. Unused bits driver 106 may be removably stored in associated detent cavities 112 formed, e.g., on the outboard side of the upper housing member 20.

Further modifications and improvements will be apparent to those persons skilled in the art. Accordingly, no limitation on the invention is intended by way of the foregoing description and accompanying drawings, except as set forth in the appended claims.

What is claimed is:

1. A multiblade knife unit, comprising:
a handle housing;
a first knife blade carried by said handle housing for pivoting displacement between a stored position nested at least partially within one side edge of said handle housing and a deployed position projecting generally from one end of said knife housing; and
a second knife blade carried by said handle housing for sliding displacement between a retracted position concealed substantially within said handle housing and an advanced position projecting generally from said one end of said knife housing;
said first and second knife blades being displaceable independent of each other.

2. The multiblade knife unit of claim 1 wherein said first and second knife blades respectively define cutting edges presented in opposite directions, when said first and second knife blades are in said deployed and advanced positions, respectively.

3. The multiblade knife unit of claim 1 wherein said first knife blade is partially nested within a slot formed in said handle housing, when said first knife blade is in said stored position.

4. The multiblade knife unit of claim 1 wherein said first knife blade further includes a short laterally extending stub post thereon for facilitated manual displacement from said stored position to said deployed position, said stub post being at least partially exposed for fingertip access at said one side edge of said handle housing when said first knife blade is in said stored position.

5. The multiblade knife unit of claim 1 further including a releasible locking device for releasibly locking said first knife blade in said deployed position.

6. The multiblade knife unit of claim 5 wherein said releasible locking device includes a spring plate for releasibly engaging and locking a matingly shaped base end of said first knife blade.

7. The multiblade knife unit of claim 6 wherein said handle housing comprises a pair of assembled housing members cooperatively defining a slot formed along said one side edge of said handle housing for nested reception of said first knife blade in said stored position, said spring plate comprising a spring member sandwiched between said housing members and including a laterally struck spring end reacting between said housing members for biasing a portion of said spring member to engage and lock said first knife blade in said deployed position.

8. The multiblade knife unit of claim 7 wherein said spring member includes a side edge exposed within said slot for fingertip access to displace said portion of said spring member to release said first knife blade for pivotal displacement from said deployed position to said stored position.

9. The multiblade knife unit of claim 8 wherein said spring member side edge is serrated.

10. The multiblade knife unit of claim 1 wherein said second knife blade comprises a razor utility blade.

11. The multiblade knife unit of claim 1 further including a slide clip removably supporting said second knife blade, said slide clip being slidably movable along a track defined by said handle housing for displacing said second knife blade between said retracted and advanced positions.

12. The multiblade knife unit of claim 11 wherein said handle housing has an elongated track port formed therein, said slide clip including an externally exposed thumb detent slidably movable along said track port.

13. The multiblade knife unit of claim 11 further including externally exposed release means on said handle housing for releasibly mounting said second knife blade on said slide clip when said second knife blade is in said advanced position, thereby permitting manual removal and replacement of said second knife blade.

14. The multiblade knife unit of claim 11 wherein said slide clip includes at least one mounting key engageable with at least one mounting recess formed in said second knife blade for mounting said second knife blade onto said slide clip, and further including an externally exposed and spring-loaded release button on said handle housing for depression and engagement with said slide clip, when said slide clip is in said advanced position, for disengaging said mounting key from said mounting recess to permit manual sliding removal and replacement of said second knife blade.

15. The multiblade knife unit of claim 14 wherein said at least one mounting key is carried on a spring arm defined by said slide clip for normal spring-biased engagement of said mounting key with said mounting recess formed in said second knife blade.

16. The multiblade knife unit of claim 1 further wherein said handle housing further defines at least one bit socket formed at a second end of said handle housing, and at least one driver bit for seated installation into said bit socket.

17. The multiblade knife unit of claim 16 further including a plurality of detent cavities formed on said handle housing for removably supporting a corresponding plurality of driver bits.

18. A multiblade knife unit, comprising:
a handle housing;
a first knife blade carried by said handle housing for pivoting displacement between a stored position nested at least partially within a slot formed in one side edge of said handle housing and a deployed position projecting generally from one end of said knife housing; and
a slide clip for removably supporting a second knife blade, said slide clip being carried by said handle housing for sliding displacement between a retracted position with a second knife blade supported thereby concealed substantially within said handle housing and an advanced position with a second knife blade supported thereby projecting generally from said one end of said knife housing;
said first knife blade and said slide clip being displaceable independent of each other.

19. The multiblade knife unit of claim 18 wherein said handle housing comprises a pair of assembled housing members cooperatively defining said slot formed along said one side edge of said handle housing for nested reception of said first knife blade in said stored position, and a spring member being sandwiched between said housing members and including a laterally struck spring end reacting between said housing members for biasing a portion of said spring plate to engage and lock said first knife blade in said deployed position.

20. The multiblade knife unit of claim 19 wherein said spring member includes a side edge exposed within said slot for fingertip access to displace said portion of said spring member to release said first knife blade for pivotal displacement from said deployed position to said stored position.

21. The multiblade knife unit of claim 18 wherein said handle housing defines a track for guiding said slide clip between said retracted and advanced positions.

22. The multiblade knife unit of claim 21 wherein said handle housing has an elongated track port formed therein, said slide clip including an externally exposed thumb detent slidably movable along said track port.

23. The multiblade knife unit of claim 21 wherein said slide clip includes at least one mounting key engageable with at least one mounting recess formed in the second knife blade for mounting the second knife blade onto said slide clip for sliding displacement therewith between said retracted and advanced position, and further including an externally exposed and spring-loaded release button on said handle housing for depression and engagement with said slide clip, when said slide clip is in said advanced position, for disengaging said mounting key from the second knife blade to permit manual sliding removal and replacement of the second knife blade.

24. The multiblade knife unit of claim 23 wherein said at least one mounting key is carried on a spring arm defined by said slide clip for normal spring-biased engagement of said mounting key with the mounting recess formed in the second knife blade.

25. The multiblade knife unit of claim 18 further wherein said handle housing further defines at least one bit socket formed at a second end of said handle housing, a plurality of driver bits, at least one of said driver bit being for seated installation into said bit socket, and a plurality of detent cavities formed on said handle housing for removably supporting a corresponding plurality of driver bits.

26. A knife unit, comprising:
a handle housing defined an elongated slide track, said handle housing further defining an elongated track port formed therein;
a slide clip carried by said handle housing for sliding displacement along said slide track between a retracted position and an advanced position, said slide clip further including a thumb detent member exposed externally through said track port;
a knife blade removably mounted on said slide clip for movement therewith between said retracted and advanced positions, said knife blade projecting at least partially from one end of said handle housing when said slide clip is in said advanced position;
said slide clip including at least one mounting key engageable with at least one mounting recess formed in said knife blade for removably mounting said knife blade onto said slide clip for sliding displacement therewith; and
a release button on said handle housing for depression and engagement with said slide clip, when said slide clip is in said advanced position, for disengaging said mounting key from said mounting recess to permit manual sliding removal and replacement of said knife blade relative to said slide clip.

27. The knife unit of claim 26 wherein said knife blade comprises a razor utility blade.

28. The knife unit of claim 26 wherein said at least one mounting key is carried on a spring arm defined by said slide clip for normal spring-biased engagement of said mounting key with said mounting recess formed in said second knife blade.
